(19) United States
(12) Patent Application Publication
(10) Pub. No.: US 2026/0197657 A1
(43) Pub. Date: Jul. 9, 2026

(54) PORTABLE DEVICE BLOCKING AND UNBLOCKING BASED ON WEARABLE DEVICE PROXIMITY

(71) Applicant: Visa International Service Association, San Francisco, CA (US)

(72) Inventors: Vaishale Sekaripuram Mahadevan, Bengaluru (IN); Mohan Kumar Sabapathy, Coimbatore (IN)

(73) Assignee: Visa International Service Association, San Francisco, CA (US)

(21) Appl. No.: 19/015,281

(22) Filed: Jan. 9, 2025

(51) Int. Cl. H04W 12/63; G06Q 20/40; H04W 12/33

(52) U.S. Cl. CPC H04W 12/63; H04W 12/33; G06Q 20/40145

(57) ABSTRACT

A system and method are provided which include receiving, by a user device comprising a first data processor, a memory storing portable device information, and a first transceiver coupled to the first data processor, data associated with a portable device, the portable device comprising a second data processor and a second transceiver, the data obtained while the user is viewing the portable device; determining, by the first data processor, that the data comprises information corresponding to the portable device information stored in the memory; and responsive to the determining, transmitting, by the user device to the portable device via a short range communication protocol, an instruction to the portable device.

Misappropriation of sensitive data is a problem of increasing significance. This can include skimming of account numbers and duplication of payment cards that are used fraudulently. As another example, a card for accessing a secure building can be stolen and misused.

To address these issues, solutions include multifactor authentication, such as where a user enters an additional code with their account number. While this can help secure the interaction, it places additional friction on the user. Other solutions include verifying credential ownership. For example, a user is requested to additionally submit a personal identification number (PIN) and/or personally identifying information (PII) (e.g., showing an identification card, providing biometrics, etc.). However, such techniques create friction and/or diminish user privacy. Accordingly, there is a need to provide ever increasing security for electronic interactions while maintaining user convenience and efficiency.

Embodiments address these and other problems, individually and collectively.

### BRIEF SUMMARY

Embodiments include a method comprising: receiving, by a user device comprising a first data processor, a memory storing portable device information, and a first transceiver coupled to the first data processor, data associated with a portable device, the portable device comprising a second data processor and a second transceiver, the data obtained while a user is viewing the portable device; determining, by the first data processor, that the data comprises information corresponding to the portable device information stored in the memory; and responsive to the determining, transmitting, by the user device to the portable device via a short-range communication protocol, an instruction to the portable device.

In some aspects, the portable device is a card with a credential printed on a surface of the card. In some aspects, the data obtained while the user is viewing the portable device is processed to generate the same information received from the portable device and confirm a match.

In some aspects, the instruction is an instruction to unlock the portable device, so that the portable device can be used to obtain a resource from a resource provider.

In some aspects, the user device is a pair of smart glasses and the data associated with the portable device comprises image data received by the smart glasses when the user is viewing the portable device.

In some aspects, the user device is a neural implant in the user of the user device and the information obtained by the user device associated with the portable device comprises electrical data received by the neural implant when the user is viewing the portable device.

In some aspects, the method further includes receiving, by the user device, the portable device information from the portable device over the short-range communication protocol; and storing, by the user device, the portable device information to the memory of the user device

Embodiments include a user device including instructions executable for performing a method as described above.

Embodiments include a method comprising: periodically receiving, by a portable device from a user device over a short range communication protocol, a signal indicating proximity of the devices; determining, by the portable device, that the signal is not received from the portable device in a threshold period; responsive to the determining, modifying a bit on the portable device to block one or more functions of the portable device; receiving, by the portable device, an indication that the user device has verified that data associated with the portable device is within a field of view of a user of the user device; and based on receiving the indication, modifying the bit to allow the one or more functions of the portable device.

In some aspects, the portable device is a card with a credential printed on a surface of the card, and the user device confirms the credential viewed by the user to verify that the data associated within the field of view of the user.

In some aspects, wherein the user device comprises one of: a pair of smart glasses, wherein the data associated with the portable device comprises image data received by the smart glasses when the user is viewing the portable device; or a neural implant in the user of the user device, wherein the data obtained by the user device associated with the portable device comprises electrical data received by the smart glasses when the user is viewing the portable device.

### BRIEF DESCRIPTION OF THE DRAWINGS

FIG. 1 shows a schematic diagram of a system and method for proximity-based blocking and unblocking of a portable device.

FIG. 2 is a diagram illustrating a method for monitoring and blocking a portable device based on wearable device proximity according to some embodiments.

FIG. 3 is a diagram illustrating a method for unblocking a portable device based on wearable device proximity according to some embodiments.

FIG. 4 shows a block diagram of a user device in the form of smart glasses according to some embodiments.

FIG. 5 shows a block diagram of a user device in the form of a neural implant according to some embodiments.

FIG. 6 a block diagram of a portable device in the form of a card according to some embodiments.

FIG. 7 is a block diagram of a portable device in the form of a mobile phone according to some embodiments.

### DETAILED DESCRIPTION

Prior to discussing various embodiments, some terms can be described in further detail.

A “user” may include an individual. In some embodiments, a user may be associated with one or more personal accounts and/or user devices. The user may also be referred to as a cardholder, account holder, or consumer in some embodiments.

A “user device” may be any suitable device that may be operated by a user. User devices may include wearable devices such as smart watches, smart glasses, smart earpieces, neural implants, etc. User devices can include processors and memories configured to analyze gathered data. The user device may also provide a short-range communication capabilities via a transceiver.

A “wearable device” may be any suitable electronic device worn on or implanted in a user. Examples of wearable devices include smart glasses, smart watches, neural implants, and smart earpieces. Wearable devices can include processors and memories configured to analyze gathered data.

A “portable device” may include a device that can be easily transported. For example, a portable device used by a user can interact with an access device in order to conduct an interaction. Examples of portable devices include payment devices, membership devices, access cards, identification devices, mobile devices, etc.

A “mobile device” can include a device that can be carried by a user. Examples of mobile devices can include a smartphone, a tablet computer, etc. In some embodiments, a mobile device can comprise one or more applications and a kernel.

An “issuer” may include any entity that issues and manages accounts. An “issuer” may typically refer to a business entity (e.g., a bank) that maintains an account for a user. An issuer may also issue payment credentials stored on a mobile device, such as a cellular telephone, smart cart card, tablet, or laptop to the consumer. An issuer may authorize or decline interactions based on interaction data. An issuer may operate an issuer server.

An “interaction” can be a reciprocal action, effect, or influence. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction may involve the exchange of monetary funds, or the exchange of goods or services for monetary funds between two individuals or entities.

An “account identifier” may include an original account identifier associated with a payment account. For example, an account identifier may be a primary account number (PAN) issued by an issuer for a card account (e.g., credit card, debit card, etc.). For instance, in some embodiments, an account identifier may include a sixteen digit numerical value such as “4147 0900 0000 1234.” The first six digits of the account identifier (e.g., “414709”) may represent an authorization entity identifier (BIN) that may identify an issuer associated with the account identifier.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “resource” may refer to a service, an item, a location, data, information, or something of value that assists a user with achieving some purpose. Some resources may be restricted, and may require a user to have an account to access the resource. Examples of resources may include software applications and related functions; online services including cloud services; goods (virtual and/or physical objects) or services related to transactions; credits, points, and/or currencies that can be exchanged for other resources; electronic devices such as servers, computers, mobile devices, gaming systems, etc. ; transportation such as vehicles or transit services, communications capabilities such as wireless services; restricted areas; media content; etc.

A “resource provider” can be any suitable entity that provides resources (e.g., goods, services, access to secure data, access to locations, or the like) during a transaction. For example, a resource providing entity can be a merchant, a venue operator, a building owner, a governmental entity, etc. A “merchant” may typically be an entity that engages in transactions and can sell goods or services, or provide access to goods or services.

Embodiments establish a link between a wearable user device such as a neural implant or smart glasses and a portable device associated with an individual. This portable device could be a powered card or a mobile device. The portable device pings the wearable device (or vice versa) in defined time intervals to ascertain that it is within a permissible range of distance from the owning individual. If the portable device detects the wearable device to be out of range, it blocks one or more functions (such as the ability to be used to obtain access to a secure resource). This helps prevent fraudulent use of the portable device to gain access to a secure resource when it is not in the proximity of the owning individual.

Embodiments further apply a wearable device aided mechanism to unblock the blocked portable device. The portable device would need to be viewed by the owning individual to be unblocked. The wearable device analyzes image data and/or electrical signals that it gathers when the owning individual is viewing the portable device, and extracts the portable device's displayed information such as the card number, expiry date, card verification value (CVV), etc. The extracted information may then be checked against the pre-stored payment data within the wearable device. Upon a successful match, the wearable device would then send a signal to the portable device instructing it to unblock itself. This method ensures that the portable device is only unblocked when it is viewed by the owning individual and not by simply being in the permissible vicinity again, thus safeguarding further against fraudulent activities.

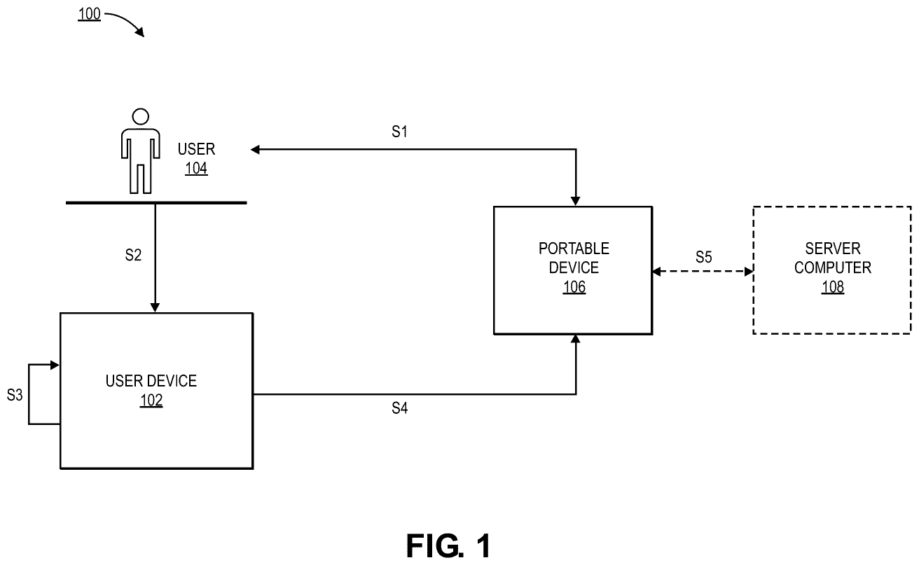

FIG. 1 shows a schematic diagram of a system 100 and method for proximity-based unblocking of a portable device, according to some embodiments. The system 100 may include a user device 102, a user 104, a portable device 106, and optionally a server computer 108.

The components in the system depicted in FIG. 1 can be in operative communication with each other through any suitable communication channel or communications network. Suitable communications networks may be any one and/or the combination of the following: a direct interconnection; a short-range communication protocol; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, Secure File Transfer Protocol (SFTP); Secure Hypertext Transfer Protocol (HTTPS), Secure Socket Layer (SSL), ISO (e.g., ISO 8583) and/or the like.

For simplicity of illustration, a certain number of components are shown in FIG. 1. It is understood, however, that embodiments may include more than one of each component. For example, there can be a plurality of portable devices 106 in operative communication with the user device 102 and/or the server computer 108.

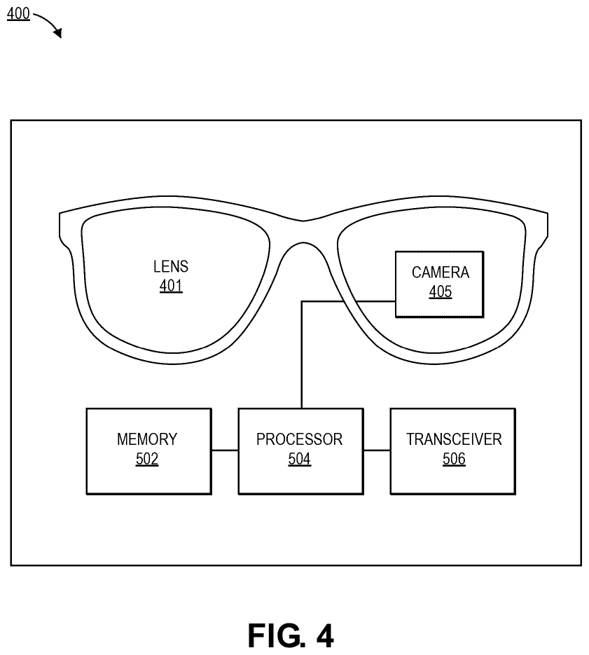

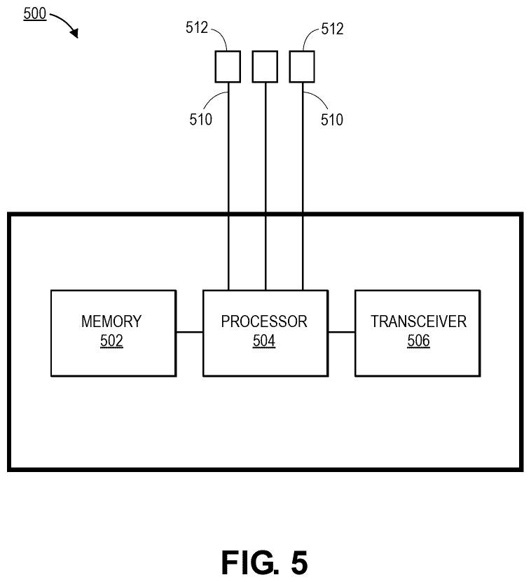

The user device 102 may be a wearable device worn on or implanted in the user 104. As examples, the user device 102 may be a neural implant, a pair of smart glasses, or the like. Components and functionalities of example user devices that can be implemented as the user device 102 are further described below with respect to FIGS. 4 and 5.

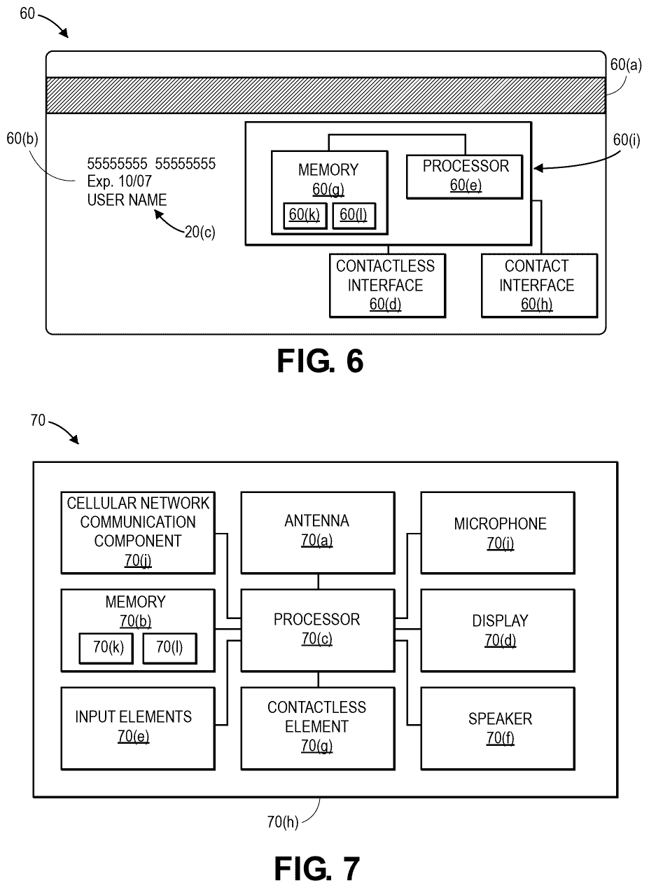

The portable device 106 may be a device useable to gain access to a secure resource, such as a payment card, building access card, library card, and so forth. The portable device 106 can include access data useable for accessing the resource (e.g., an account number), as well as a short-range communication transceiver. In some aspects, the portable device is a card with a credential printed on a surface of the card. Components and functionalities of an example portable device 106 in the form of a card are further described below with respect to FIG. 6. In some embodiments, the portable device 106 is an electronic device such as a smartphone, which can include functionality to store and display access data. An example of a portable device in the form of an electronic device is further described below with respect to FIG. 7.

The optional server computer 108 may include functionality to instruct the portable device 106 to enable or disable certain functions. In some implementations, the server computer 108 performs additional checks or oversight operations as described herein. In some aspects, the server computer 108 is an issuer server associated with an issuer of an account corresponding to the portable device 106. The server computer 108 may include a processor coupled to a network interface and a non-transitory computer readable medium including instructions executable by the processor for performing the operations described herein.

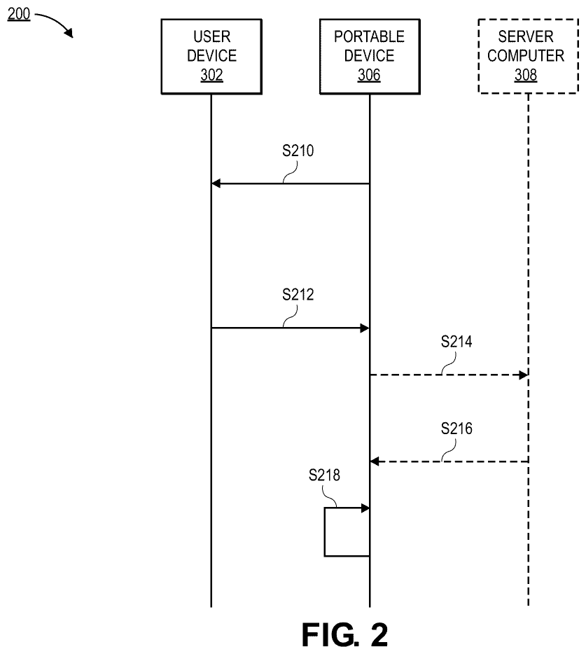

The steps shown in FIG. 1 unblock the portable device. The portable device may have already been blocked as described below with respect to FIG. 2, or may need to be unlocked at an initial time.

At step S1, the user 104 views the portable device 106. For example, the user 104 views data displayed on the portable device 106, such as an account number. At step S2, the displayed data is identified by the user device 102. In some examples, the user device 102 is a pair of smart glasses and the displayed data is captured using a camera of the smart glasses. Alternatively, the user device 102 includes a neural implant and the neural implant detects neural voltage signals which are generated by the user's brain when the user reads the numbers.

At step S3, the user device 102 extracts information from the viewed data. For example, the user device 102 extracts card details such as card number, expiration date, and/or CVV. The user device 102 compares the extracted information to stored data. If there is a match, then the user device 102 proceeds to step S4. If there is not a match, then the user device 102 does not proceed to step S4.

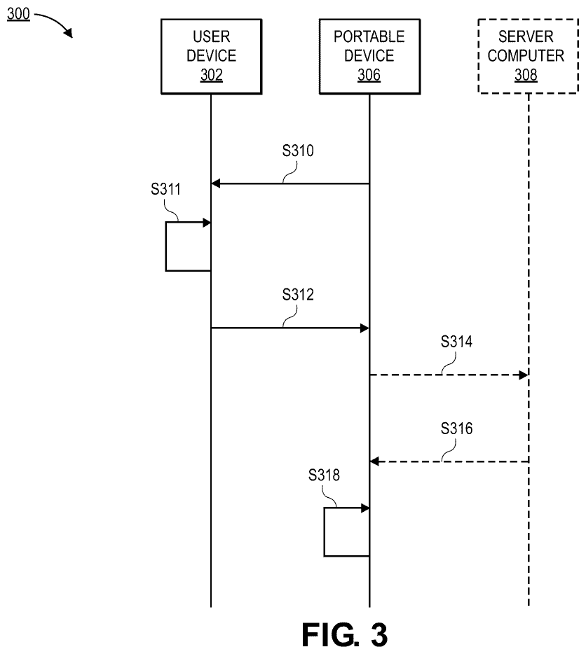

At step S4, the user device 102 sends a signal to the portable device indicating the match. The portable device 106 can then unblock itself, alone or in coordination with the server computer 108, as described further below with respect to FIG. 3.

FIG. 2 is a diagram illustrating a method 200 for monitoring and blocking a portable device, according to various embodiments. The operations of FIG. 2 may be performed by a user device 202, portable device 206, and optionally a server computer 208, which are similar to the user device 102, portable device 106, and server computer 108 of FIG. 1.

At step S210, the portable device 206 periodically receives, from the user device 202, a signal indicating proximity of the devices. For example, the user device and the portable device are each equipped with a transceiver. The user device periodically sends a signal to the portable device via the respective transceivers to confirm proximity.

In other implementations, the portable device can send a signal periodically to the user device to confirm proximity in a similar fashion. For example, the portable device pings the user device in defined time intervals to ascertain that it is within a permissible range of distance from the owning individual.

At step S212, the portable device determines that the signal is not received from the user device in a threshold period. As an example, signals received from the user device are associated with timestamps or counters, used by the user device to determine whether two signals are received within a threshold period of time. The portable device may identify a predetermined threshold period of time. The portable device may compare the time since the last signal was received to the threshold value to determine whether or not the signal is received in the threshold period.

At step S218, responsive to the determining, the portable device blocks one or more functions of the portable device. This may include modifying a bit on the portable device so that functionality of the portable device is locked or disabled. For example, the portable device 206 may set a particular Boolean flag in its microprocessor which indicates that the portable device 206 has blocked itself due to failure to detect the user device 202 within the acceptable range. As a specific example, the portable device 206 is blocked from being used to obtain a resource from a resource provider, such as entering a secure area or making a purchase.

In some implementations, optional steps S214 and S216 are performed to involve a server computer 208 in the blocking process. For example, the portable device 206 is a smartphone or other device equipped with a network interface for performing communications over a network such as the Internet. At step S214, the portable device 206 forwards the indication received at step S212 to the server computer 208. The server computer may take an appropriate action that may have been pre-configured by the issuer or user, such as blocking the portable device until specifically asked to unblock by the user or enforcing additional authentication steps, thus safeguarding physical payment instruments from theft. At step S216, the server computer 208 may disable one or more functions of the portable device 206 (e.g., by blocking the functionality of the account at the server computer database). Alternatively, or additionally, the server computer 208 sends an instruction to the portable device 206 at step S216, causing the portable device to block itself at step S218.

The portable device may subsequently unblock itself responsive to an indication of proximity from the user device, as now described with respect to FIG. 3.

FIG. 3 is a diagram illustrating a method 300 for unblocking a portable device, according to various embodiments. The operations of FIG. 3 may be performed by a user device 302, portable device 306, and optionally a server computer 308, which are similar to the user device 102, portable device 106, and server computer 108 of FIG. 1.

At step S310, the user device receives data associated with a portable device. The data is obtained while the user is viewing the portable device. For example, as described above, the portable device is a card with a credential printed on a surface of the card. The user views the portable device, causing the user device to receive the data. In other examples, the credential can be displayed on a mobile device (e.g., via a wallet application). As described above, any suitable data can be displayed, such as library card numbers, building access codes, and the like. In either case, the portable device can include a data processor (e.g., a second data processor) and a transceiver (e.g., a second transceiver) coupled to the second data processor. The received data may be in the form of an image and/or electrical signals depending on the implemented user device.

At step S311, the portable device 306 (e.g., the first data processor of the portable device 306) determines that the data identified at step S310 includes information corresponding to the portable device information stored in the memory.

In some aspects the user device receives the portable device information from the portable device. The user device may receive the portable device information from the portable device over a short-range communication protocol (e.g., via respective transceivers of the user device and portable device). The user device may receive the portable device information from the portable device during the method 300 or at an initial time. The user device may then store the portable device information to the memory of the user device.

Determining that the data obtained while the user is viewing the portable device may include processing the obtained data to generate the same portable device information stored in the memory and confirm a match.

In some examples, the user device is a pair of smart glasses. The user views the portable device. The data associated with the portable device includes image data received by the smart glasses when the user is viewing the portable device. The image captured by the smart glasses when the user is viewing the portable device is processed by the smart glasses. When the user views the portable device through the smart glasses, a camera of the wearable device acquires an image. This image may be processed by the processor of the smart glasses, using image processing techniques such as optical character recognition (OCR), to extract numbers and/or letters from the image.

In some examples, the user device is a neural implant, which may be implanted in a user of the user device. The image captured by the eye (or a visual prosthetic in the case of visually challenged owners) is processed by the implant. When the user views the portable device, their brain transmits electrical signals indicative of the viewed information. The information obtained by the user device associated with the portable device includes electrical data received by the neural implant when the user is viewing the portable device. Electrodes of the neural implant detect the electrical signals, which can then be analyzed by the processor of the neural implant to decode numbers and/or letters. This can be executed using techniques such as applying a neural decoding algorithm and/or machine learning model to covert the electrical signals to what numbers and/or letters the user is viewing.

In either case, the user device can include a first data processor, a memory storing portable device information, and a first transceiver coupled to the first data processor, which are used to convert and compare the information on the portable device to the stored information.

The user device may store portable device data such as the card number, expiry date, CVV, etc. The user device extracts the displayed data from the portable device and checks it against the pre-stored portable device data within the user device. If there is a match, then the user device 302 may proceed to step S312. If there is not a match, the user device 302 may refrain from proceeding to step S312.

At step S312, the user device 302 transmits an instruction to the portable device 306. Upon a successful match, the user device 302 sends a signal to the portable device 306 instructing it to unblock itself. In some aspects, the user device 302 transmits the instruction to the portable device 306 via a short range communication protocol (e.g., using respective transceivers). For example, the instruction may be in the form of a message or binary signal indicating that the portable device 306 should be unblocked.

The portable device receives an indication that the user device has verified that data associated with the portable device is within the field of view of a user of the user device. The portable device receives the above-mentioned message and/or signal from the user device.

At step S318, based on receiving the indication, the portable device allows one or more functions of the portable device. This may include modifying a bit on the portable device, so that functionality of the portable device is unlocked. For example, the instruction transmitted at step S312 is an instruction to unlock the portable device, so that the portable device can be used to obtain a resource from a resource provider.

Subsequently, the unblocked functionality can be used to obtain access to a secure resource. For example, the portable device is enabled to initiate a payment transaction. Payment information of the portable device is transmitted to an access device which prepares an authorization request message, sends it to suitable device(s) for approval, and can complete the transaction upon receiving an authorization response message. As another example, the portable device is enabled to open a door to a secure area. Access information of the portable device is transmitted to an access device which causes the door to open.

In some implementations, optional steps S314 and S316 are performed to involve a server computer 308 in the unblocking process. At step S314, the portable device 306 forwards the indication received at step S312 to the server computer 308. The server computer may perform additional checks such as validating the status of the account associated with the portable device 306. At step S316, the server computer 308 may unlock the portable device 306. Alternatively, the server computer 308 sends an instruction to the portable device 306 at step S316, causing the portable device to unlock itself at step S318.

Embodiments provide several advantages. The portable device can be blocked and unblocked based on proximity to a user device, in order to ensure that the user is near the portable device and it is not being used fraudulently. This improves the security of the system. Additional security improvements are provided by ensuring that the portable device is only unblocked when it is viewed by the user owning the portable device and not by simply being in the permissible vicinity again, thus safeguarding further against fraudulent activities. This unblocking mechanism ensures that the actual owner holds and views the card, thus preventing a fraudster from merely unblocking the card by using proximity. The unblocking mechanism practically requires the owner to do no special action other that just hold and look at the portable device. This makes it less cumbersome than existing unblocking solutions.

FIG. 4 shows a block diagram of a user device in the form of smart glasses 400 according to some embodiments. The smart glasses 400 include a lens 401 and a camera 405. The smart glasses 400 may comprise a processor 404. The processor 404 may be coupled to a memory 402 and a transceiver 406.

The processor 404 may be implemented as one or more integrated circuits (e.g., one or more single core or multicore microprocessors and/or microcontrollers). The processor 404 may be used to control the operation of the smart glasses 400. The smart glasses 400 can execute a variety of programs in response to program code or computer-readable code stored in memory.

The memory 402 can be used to store data and code. The memory 402 may be coupled to the processor 504, and may comprise any combination of volatile and/or non-volatile memory, such as RAM, DRAM, ROM, flash, or any other suitable memory device.

The transceiver 406 may include an interface that can allow the smart glasses 400 to communicate with external devices. The transceiver 406 may enable the smart glasses 400 to communicate data to and from another device (e.g., the portable device 106, server computer 108, etc.). The transceiver 406 may enable short-range wireless communication protocols such as Bluetooth® (e.g., IEEE 802.15.1 standard), ZigBee®, (e.g., IEEE 802.15.4 standard), or a custom short-range wireless communication protocol. Data transferred via the transceiver 406 may be in the form of signals which may be electrical, electromagnetic, optical, or any other signal capable of being received by the external communications interface (collectively referred to as “electronic signals” or “electronic messages”).

The memory 402 can store software code stored as a series of instructions or commands. The memory 402 may comprise code, executable by the processor 60(e), to implement a method comprising: receiving, by a user device comprising a first data processor, a memory storing portable device information, and a first transceiver coupled to the first data processor, data associated with a portable device, the portable device comprising a second data processor and a second transceiver, the data obtained while a user is viewing the portable device; determining, by the first data processor, that the data comprises information corresponding to the portable device information stored in the memory; and responsive to the determining, transmitting, by the user device to the portable device via a short-range communication protocol, an instruction to the portable device.

FIG. 5 shows a block diagram of a user device in the form of a neural implant 500 according to some embodiments. The neural implant 500 includes a set of electrodes 512 coupled to leads 510. The neural implant 500 may comprise a processor 504. The processor 504 may be coupled to the leads 510, a memory 502, and a transceiver 506.

The electrodes 512 receive and/or transmit information to/from the brain of the user. The electrodes 512 may be implanted into the brain of the user. The electrodes 512 are coupled to leads 510 that transmit the information from the brain to the processor 504 (and vice versa). The information may include electrical signals or voltage readings that can be analyzed by the processor 504.

The memory 502, processor 504, and transceiver 506 may be substantially similar to the memory 402, processor 404, and transceiver 406, as described above with respect to FIG. 4.

The memory 502 can store software code stored as a series of instructions or commands. The memory 502 may comprise code, executable by the processor 504, to implement a method comprising: receiving, by a user device comprising a first data processor, a memory storing portable device information, and a first transceiver coupled to the first data processor, data associated with a portable device, the portable device comprising a second data processor and a second transceiver, the data obtained while a user is viewing the portable device; determining, by the first data processor, that the data comprises information corresponding to the portable device information stored in the memory; and responsive to the determining, transmitting, by the user device to the portable device via a short-range communication protocol, an instruction to the portable device.

FIG. 6 shows one embodiment of a portable device that may be used in an embodiment of the invention. The portable device 60 may be in the form of a credit, debit, or prepaid card having both a contact interface 60(h) and/or a contactless interface 60(d). The contact interface 60(h), which may be in the form of a chip plate, allows the portable device 60 to perform an interaction by having the contact interface to come in direct contact with a second contact interface at a card terminal (or other type of POS terminal or access device). In some embodiments, a secondary contact interface 60(a), such as a magnetic stripe, can also be located on the portable device 60. Stored card information 60(b) including financial data (e.g., an account number) can be sent from the card 60 to the card terminal when they are in contact with each other. The contactless interface 60(d) can communicate with the card terminal using a contactless interface at the card terminal. An antenna coupled to an integrated circuit (IC) chip may form at least part of the contactless element 60(d), which is used to wirelessly transmit the stored card information to external devices such as a card terminal. The contactless element 60(d) may include a transceiver.

The memory 60(g) and the processor 60(e) may be substantially similar to the memory 402 and processor 404, as described above with respect to FIG. 4.

The memory 60(g) can store software code stored as a series of instructions or commands. The memory 60(g) may comprise code, executable by the processor 60(e), to implement a method comprising: periodically receiving, from a user device over a short range communication protocol, a signal indicating proximity of the devices; determining that the signal is not received from the portable device in a threshold period; responsive to the determining, modifying a bit on the portable device to block one or more functions of the portable device; receiving, by an indication that the user device has verified that data associated with the portable device is within the field of view of a user of the user device; and based on receiving the indication, modifying the bit to allow the one or more functions of the portable device.

The memory 60(g) may include a blocking module 60(k) and a proximity module 60(l). Each of these modules may include code configured to perform the functions described above in conjunction with the processor 60(e). The blocking module 60(k) can enable or disable functionality of the portable device 60 (e.g., by modifying a binary bit). The proximity module 60(l) can periodically communicate with a user device to determine whether proximity conditions are met.

In an alternative embodiment, FIG. 7 shows a block diagram showing components in a portable device 70 in the form of a cellular or mobile communication device that can be used in embodiments of the invention. The exemplary portable device 70 may comprise a memory 70(b), a cellular network communication component 70(j) and a body 70(h). The cellular network component 70(j) may act as a communication interface, similar to the contact interface on the payment card, to communicate with external devices and provide updates to the portable device. The body 70(h) may be in the form a plastic substrate, housing, or other structure. The memory 70(b) may be in the form of (or may be included in) a memory that stores data (e.g., issuer account numbers and other elements of payment data) and may be in any suitable form including a memory chip, etc. The memory preferably stores information such as financial information and software modules which control the functions within the device. Financial information may include information such as bank account information, a bank identification number (BIN), credit or debit card number information, account balance information, expiration date, consumer information such as name, date of birth, etc. Any of this information may be transmitted and displayed by the portable device 70.

The memory 70(g) can store software code stored as a series of instructions or commands. The memory 70(g) may comprise code, executable by the processor 70(e), to implement a method comprising: periodically receiving, from a user device over a short range communication protocol, a signal indicating proximity of the devices; determining that the signal is not received from the portable device in a threshold period; responsive to the determining, modifying a bit on the portable device to block one or more functions of the portable device; receiving, by an indication that the user device has verified that data associated with the portable device is within the field of view of a user of the user device; and based on receiving the indication, modifying the bit to allow the one or more functions of the portable device.

The memory 70(g) may include a blocking module 70(k) and a proximity module 70(l). Each of these modules may include code configured to perform the functions described above in conjunction with the processor 70(c). The blocking module 70(k) can enable or disable functionality of the portable device 70 (e.g., by modifying a binary bit). The proximity module 70(l) can periodically communicate with a user device to determine whether proximity conditions are met.

The portable device 70 may further include a contactless element 70(g), which is typically implemented in the form of a semiconductor chip (or other data storage element) with an associated wireless transfer (e.g., data transmission) element, such as an antenna. Contactless element 70(g) is associated with (e.g., embedded within) phone 70 and data or control instructions transmitted via a cellular network may be applied to contactless element 70(g) by means of a contactless element interface (not shown). The contactless element interface functions to permit the exchange of data and/or control instructions between the mobile device circuitry (and hence the cellular network) and external devices. The contactless element 70(g) may include a transceiver.

Contactless element 70(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the phone 70 and other devices such as a user device. Thus, the phone 70 is capable of communicating and transferring data and/or control instructions via both cellular network and near field communications capability.

The portable device 70 may also include a processor 70(c) (e.g., a microprocessor) for processing the functions of the phone 70 and a display 70(d) to allow a user to see account information, phone numbers, and other information and messages. The phone 70 may further include input elements 70(e) to allow a user to input information into the device, a speaker 70(f) to allow the consumer to hear voice communication, music, etc., and a microphone 70(i) to allow the user to transmit her voice through the phone 70. The phone 70 may also include an antenna 70(a) for wireless data transfer (e.g., data transmission).

Any of the software components or functions described in this application, may be implemented as software code to be executed by a processor using any suitable computer language such as, for example, Java, C++ or Perl using, for example, object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a user device comprising a first data processor, a memory storing portable device information, and a first transceiver coupled to the first data processor, data associated with a portable device, the portable device comprising a second data processor and a second transceiver, the data obtained while a user is viewing the portable device;
determining, by the first data processor, that the data comprises information corresponding to the portable device information stored in the memory; and
responsive to the determining, transmitting, by the user device to the portable device via a short-range communication protocol, an instruction to the portable device.

2. The method of claim 1, wherein the portable device is a card with a credential printed on a surface of the card.

3. The method of claim 1, wherein the data obtained while the user is viewing the portable device is processed to generate the same information received from the portable device and confirm a match.

4. The method of claim 1, wherein the instruction is an instruction to unlock the portable device, so that the portable device can be used to obtain a resource from a resource provider.

5. The method of claim 1, wherein the user device is a pair of smart glasses and the data associated with the portable device comprises image data received by the smart glasses when the user is viewing the portable device.

6. The method of claim 1, wherein the user device is a neural implant in the user of the user device and the information obtained by the user device associated with the portable device comprises electrical data received by the neural implant when the user is viewing the portable device.

7. The method of claim 1, further comprising:
receiving, by the user device, the portable device information from the portable device over the short-range communication protocol; and
storing, by the user device, the portable device information to the memory of the user device.

8. A user device comprising:
a first data processor;
a first transceiver coupled to the first data processor;
a memory storing portable device information; and
instructions executable by the first data processor for:
receiving data associated with a portable device, the data obtained while a user is viewing the portable device;
determining that the data comprises information corresponding to portable device information stored in the memory; and
responsive to the determining, transmitting, to the portable device via a short-range communication protocol, an instruction to the portable device.

9. The user device of claim 8, wherein the user device is a pair of smart glasses.

10. The user device of claim 9, wherein the data associated with the portable device comprises image data received by the smart glasses when the user is viewing the portable device.

11. The user device of claim 8, wherein the user device is a neural implant in the user of the user device.

12. The user device of claim 11, wherein the information obtained by the user device associated with the portable device comprises electrical data received by the neural implant when the user is viewing the portable device.

13. The user device of claim 8, wherein the data obtained while the user is viewing the portable device is processed to generate the same information received from the portable device and confirm a match.

14. The user device of claim 8, wherein the instruction is an instruction to unlock the portable device, so that the portable device can be used to obtain a resource from a resource provider.

15. The user device of claim 8, wherein the portable device is a card with a credential printed on a surface of the card.

16. The user device of claim 8, the instructions further executable by the first data processor for:
receiving the portable device information from the portable device over the short-range communication protocol; and
storing the portable device information to the memory of the user device.

17. A method comprising:
periodically receiving, by a portable device from a user device over a short range communication protocol, a signal indicating proximity of the devices;
determining, by the portable device, that the signal is not received from the portable device in a threshold period;
responsive to the determining, modifying a bit on the portable device to block one or more functions of the portable device;
receiving, by the portable device, an indication that the user device has verified that data associated with the portable device is within a field of view of a user of the user device; and
based on receiving the indication, modifying the bit to allow the one or more functions of the portable device.

18. The method of claim 17, wherein:
the user device comprises a first data processor and a first transceiver coupled to the first data processor, and
the portable device comprising a second data processor and a second transceiver.

19. The method of claim 17, wherein:
the portable device is a card with a credential printed on a surface of the card, and
the user device confirms the credential viewed by the user to verify that the data associated within the field of view of the user.

20. The method of claim 17, wherein the user device comprises one of:
a pair of smart glasses, wherein the data associated with the portable device comprises image data received by the smart glasses when the user is viewing the portable device; or
a neural implant in the user of the user device, wherein the data obtained by the user device associated with the portable device comprises electrical data received by the smart glasses when the user is viewing the portable device.
